(19) United States
(12) Patent Application Publication
(10) Pub. No.: US 2026/0246088 A1
(43) Pub. Date: Aug. 20, 2026

(54) SEPARATOR FOR ALKALINE DRY BATTERY AND ALKALINE DRY BATTERY

(71) Applicant: Panasonic Intellectual Property Management Co., Ltd., Osaka (JP)

(72) Inventors: JUN NUNOME, Kyoto (JP); SATOSHI FUJIYOSHI, Osaka (JP); KEISUKE TAKAHASHI, Osaka (JP)

(21) Appl. No.: 19/153,885

(22) PCT Filed: Nov. 8, 2023
(86) PCT No.: PCT/JP2023/040231

§ 371 Date: Aug. 5, 2025

(30) Foreign Application Priority Data
Feb. 14, 2023 (JP) 2023-021096

(51) Int. Cl. H01M 50/44; H01M 6/06; H01M 50/414

(52) U.S. Cl. CPC H01M 50/44; H01M 6/06; H01M 50/414

(57) ABSTRACT

A separator for an alkaline dry battery is disposed between a positive electrode and a negative electrode containing zinc in the alkaline dry battery which includes the positive electrode, the negative electrode, and an electrolytic solution. The separator includes a sulfate salt within a range of 0.08 mg or more and 1.7 mg or less in terms of sulfate ions per 1 cm² of a facing area of the positive electrode and the negative electrode.

### BACKGROUND

### 1. Technical Field

The present disclosure relates to an alkaline dry battery, and more particularly to a separator for use in an alkaline dry battery.

### 2. Description of the Related Art

An alkaline dry battery (e.g., an alkaline manganese dry battery) is widely used because the alkaline dry battery has a larger battery capacity than a manganese dry battery and can extract a larger current. The alkaline dry battery usually includes a positive electrode, a negative electrode, a separator disposed between the positive electrode and the negative electrode, and an alkaline electrolytic solution. The positive electrode contains manganese dioxide as a positive electrode active material. Various proposals have been made to improve the characteristics of alkaline dry batteries.

Patent Literature 1 proposes a separator for an alkaline battery, the separator being obtained by attaching a crosslinked superabsorbent polymer compound having a carboxyl group to a wet-laid non-woven fabric containing alkali-resistant fibers in an amount of 5.0 to 45.0 g/m² and bonding the wet-laid non-woven fabric containing the alkali-resistant fibers to a crosslinked base material, wherein a silicate compound is added to the crosslinked superabsorbent polymer compound in an amount of 1.0×10⁻⁴ to 10 mg/cm² per unit area of the separator.

Patent Literature 2 proposes that, in an alkaline battery including a positive electrode, a negative electrode containing zinc, and an electrolytic solution, a calcium compound or a sulfuric acid compound is added to at least one of the positive electrode, the negative electrode, and the electrolytic solution to prevent a decrease in discharge voltage under a heavy load discharge condition. According to Patent Literature 2, since sulfate ions migrate toward the negative electrode together with H₂O during discharge, the volume of the electrolytic solution in the vicinity of the negative electrode is sufficient even under the heavy load discharge conditions, and a decrease in discharge voltage is suppressed.

### CITATION LIST

### Patent Literature

Patent Literature 1: Unexamined Japanese Patent Publication 2007-227067
Patent Literature 2: Unexamined Japanese Patent Publication 2001-297776

### SUMMARY

In an alkaline dry battery in which zinc is used as a negative electrode, in which an alkaline aqueous solution is used as an electrolytic solution, and in which a porous separator is used as a separator, fine crystals of zinc oxide having conductivity may be deposited in the separator during intermittent discharge under a medium load (for example, 3.9Ω), and an internal short circuit may occur to decrease the discharge duration.

According to Patent Literature 1, by adding a silicate compound to a separator within a range of 1.0×10⁻⁴ to 10 mg/cm² per unit area of the separator, the silicate compound forms an intermolecular network structure with a crosslinked superabsorbent polymer compound, and short circuit due to dendrites can be prevented. However, in the separator described in Patent Literature 1, although the precipitation of zinc oxide is easily suppressed by the addition of the silicate compound, the ion conductivity of the electrolyte is decreased, and the discharge characteristics may be decreased. In addition, it cannot be said that the effect of suppressing the precipitation of zinc oxide in use in medium load intermittent discharge is sufficient, and it is required to suppress an internal short circuit due to the precipitation of zinc oxide at a higher level.

One aspect of the present disclosure relates to a separator for an alkaline dry battery, the separator being disposed between a positive electrode and a negative electrode of an alkaline dry battery including the positive electrode, the negative electrode containing zinc, and an electrolytic solution, the separator containing 0.08 mg or more and 1.7 mg or less of a sulfate salt in terms of sulfate ions per 1 cm² of an area where the positive electrode and the negative electrode face each other.

Another aspect of the present disclosure relates to an alkaline dry battery including: the positive electrode having a cylindrical shape and disposed in a battery case; the negative electrode in a gel state containing zinc powder and filled in a hollow portion of the positive electrode; and a separator disposed between the positive electrode and the negative electrode, wherein the separator includes the alkaline dry battery separator described above.

In the present disclosure, by using an alkaline dry battery separator, it is possible to realize an alkaline dry battery in which occurrence of an internal short circuit during medium load intermittent discharge is suppressed.

### BRIEF DESCRIPTION OF DRAWING

FIG. 1 is a partially exploded cross-sectional view illustrating an example of an alkaline dry battery according to an embodiment.

### DESCRIPTION OF EMBODIMENT

Hereinafter, embodiments according to the present disclosure will be described with examples, but the present disclosure is not limited to the examples described below. In the following description, specific numerical values and materials may be exemplified, but other numerical values and other materials may be applied as long as the invention according to the present disclosure can be implemented. In the specification, the expression “numerical value A to numerical value B” includes the numerical value A and the numerical value B, and can be read as “numerical value A or more and numerical value B or less”. In the following description, when lower limits and upper limits of numerical values relating to specific physical properties and conditions are exemplified, any of the exemplified lower limits and any of the exemplified upper limits can be arbitrarily combined as long as the lower limit is not equal to or greater than the upper limit. When a plurality of materials are exemplified, one of them may be selected and used alone, or two or more thereof may be used in combination.

Furthermore, the present disclosure encompasses a combination of matters recited in two or more claims arbitrarily selected from a plurality of claims recited in the claims. That is, the matters recited in two or more claims arbitrarily selected from a plurality of claims recited in the claims can be combined as long as no technical contradiction arises.

### (Separator for Alkaline Dry Battery)

A separator for an alkaline dry battery according to an exemplary embodiment (hereinafter, may be simply referred to as a “separator”) is disposed between a positive electrode and a negative electrode of an alkaline dry battery including the positive electrode, the negative electrode containing zinc, and an electrolytic solution. The separator contains 0.08 mg or more and 1.7 mg or less of a sulfate salt in terms of sulfate ions per 1 cm² of a facing area of the positive electrode and the negative electrode.

By including the sulfate salt in the separator, an internal short circuit due to precipitation of zinc oxide in a use environment of medium load intermittent discharge is suppressed, and an alkaline dry battery having excellent medium load intermittent discharge characteristics can be realized.

The precipitation of zinc oxide is considered to be caused by the phenomenon that OH⁻ ions in the electrolytic solution in the negative electrode are consumed by discharge, the pH of the electrolytic solution is lowered, and the pH of the electrolytic solution is changed toward neutrality, whereby the solubility of zinc ions dissolved in the electrolytic solution is lowered. In particular, in a use environment in which discharge is intermittently repeated for about one hour per day at a medium load of a current of about 250 mA to 500 mA, a local decrease in pH of the electrolytic solution is remarkable, and the electrolytic solution is likely to be locally neutralized. As a result, an internal short circuit due to precipitation of zinc oxide is likely to occur.

In an undischarged alkaline dry battery, the sulfate salt is hardly dissolved in the electrolytic solution because the electrolytic solution is strongly alkaline. However, when the pH of the electrolytic solution in the negative electrode decreases with discharge, the sulfate salt is easily dissolved, and the pH of the electrolytic solution further decreases to the acidic side. On the other hand, the solubility of zinc ions is lowest in a neutral state, and zinc ions are easily dissolved in an alkaline state and an acidic state. Therefore, when the sulfate salt is dissolved in the middle of the medium load intermittent discharge, the pH of the electrolytic solution is changed from neutrality to the acidic side, whereby zinc ions are easily dissolved, and precipitation of zinc oxide in the separator is suppressed.

In addition to the separator, the negative electrode may also contain a sulfate salt. However, since the internal short circuit due to the precipitation of zinc oxide occurs when the pH of the electrolytic solution in the separator is changed toward neutrality, it is effective that the sulfate salt acting on the pH of the electrolytic solution in the separator is present in the separator.

Note that, under a discharge condition of a heavy load (for example, about 1 A), the discharge voltage of the alkaline dry battery usually decreases before the electrolytic solution becomes neutral, and the alkaline dry battery reaches the end of its life. Therefore, the problem of an internal short circuit due to precipitation of zinc oxide hardly occurs.

Since the content of the sulfate salt contained in the separator is 0.08 mg or more in terms of sulfate ions per 1 cm² of the facing area in the region where the positive electrode and the negative electrode of the separator face each other, the effect of suppressing an internal short circuit due to precipitation of zinc oxide can be sufficiently obtained. On the other hand, when the content of the sulfate salt is excessive, the pores inside the separator are easily clogged, and the ion conductivity may decrease or the liquid retention property of the electrolytic solution may decrease.

The content of the sulfate salt is 1.7 mg or less in terms of sulfate ions per 1 cm² of the facing area from the viewpoint of suppressing a decrease in ion conduction and a decrease in liquid retention. The content of the sulfate salt is 0.08 mg or more and 1.7 mg or less, preferably 0.1 mg or more and 1.0 mg or less, and more preferably 0.15 mg or more and 0.8 mg or less, per 1 cm² of the facing area in terms of sulfate ions.

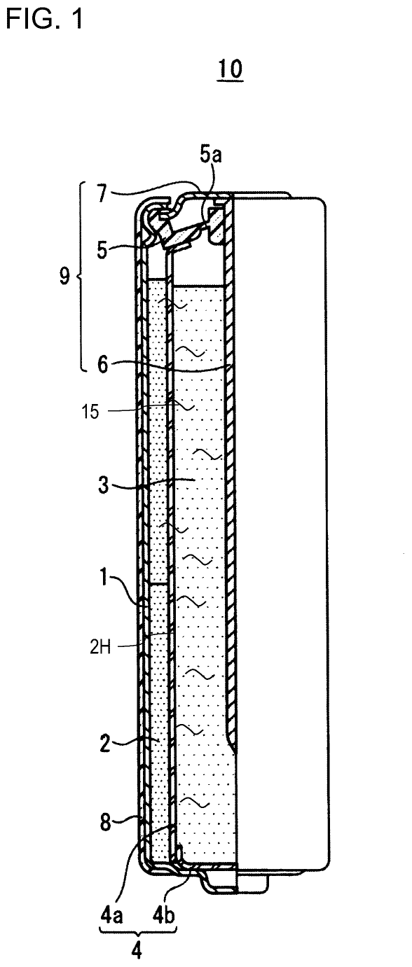

The sulfate salt may be contained in the above content in a portion of the separator facing the positive electrode and the negative electrode and sandwiched between the positive electrode and the negative electrode. As an example of the structure of the separator, as shown in FIG. 1, which will be described later, there is a structure including a cylindrical portion sandwiched between the positive electrode and the negative electrode, and a bottom portion sandwiched between the negative electrode and the battery case. In this case, at least the cylindrical portion out of the cylindrical portion and the bottom portion may contain the sulfate salt within the above range. The bottom portion is not particularly limited, and a general separator containing no sulfate salt may be used.

When one separator is used, the content of the sulfate salt per 1 cm² of the facing area means the content of the sulfate salt per 1 cm² of the separator in the region where the positive electrode and the negative electrode face each other. On the other hand, a plurality of separators may be stacked so as to have a desired total thickness, or one separator may be wound a plurality of times and stacked so as to have a desired total thickness. In this case, the content of the sulfate salt per 1 cm² of the facing area is the total content of the sulfate salt per 1 cm² of the separator of each layer in the region where the positive electrode and the negative electrode face each other.

In addition, the content of the sulfate salt in terms of sulfate ions means the content by mass of sulfate ions (SO₄²⁻) out of cations and sulfate ions constituting the sulfate salt included in the separator.

The content of the sulfate salt is determined by disassembling an undischarged alkaline dry battery, collecting at least a part (for example, 80% or more) of the separator in a region where the positive electrode and the negative electrode face each other, measuring the mass thereof, exposing the collected negative electrode to pure water to dissolve the sulfate salt in the pure water, and performing ion chromatography. The content of the sulfate salt in terms of sulfate ions is determined by quantifying SO₄²⁻ by ion chromatography and calculating the mass occupied in the negative electrode. The sulfate salt content in terms of sulfate ions per 1 cm² of the facing area is determined by dividing the content of the sulfate salt in terms of sulfate ions by the area of the collected separator.

The cation constituting the sulfate salt is not particularly limited as long as it does not hinder the discharge reaction of the battery. The sulfate salt may be a salt of a metal cation and a sulfate ion. The sulfate salt preferably contains at least one selected from the group consisting of potassium sulfate salt, sodium sulfate salt, aluminum sulfate salt, aluminum potassium sulfate salt, calcium sulfate salt, zinc sulfate salt, and lithium sulfate salt, and also preferably contains a hydrate thereof, from the viewpoint of a large effect of lowering the pH after the dissolution.

As the separator, a non-woven fabric mainly composed of fibers or a microporous film made of a resin is used. Examples of the material of the fiber include cellulose and polyvinyl alcohol. The non-woven fabric may be formed by mixing cellulose fibers and polyvinyl alcohol fibers, or may be formed by mixing rayon fibers and polyvinyl alcohol fibers. Examples of the material of the microporous film include resins such as cellophane and polyolefin. When the separator is thin, a plurality of separators may be stacked and adjusted to the above thickness.

The substrate used in the alkaline dry battery separator of the disclosure may be at least one of a synthetic fiber having excellent alkali resistance or an alkali-resistant cellulose fiber. Examples of the synthetic fiber having excellent alkali resistance include at least one selected from the group consisting of a polyvinyl alcohol-based fiber, an ethylene-vinyl alcohol-based copolymer fiber, a polypropylene fiber, a polyethylene fiber, a polyamide fiber, a polypropylene/polyethylene composite fiber, and a polypropylene/ethylene-vinyl alcohol-based copolymer composite fiber. Polyvinyl alcohol may be included in the synthetic fibers as a binder. For example, a synthetic fiber in which a polyvinyl alcohol-based fiber, a cellulose fiber, and a polyvinyl alcohol-based binder are blended within a range of 30 to 60% by mass of the polyvinyl alcohol-based fiber, 30 to 60% by mass of the cellulose fiber, and 5 to 23% by mass of the polyvinyl alcohol-based binder may be used.

Preferably, the separator may be a non-woven fabric produced by wet papermaking of these fibers.

Among these fibers, the separator preferably contains a polyvinyl alcohol-based fiber. Since the polyvinyl alcohol-based fiber has excellent affinity (i.e., wettability) with water, when an aqueous solution of a sulfate salt is used in the production method (ii) or (iii), which will be described later, the sulfate salt is likely to adhere between fibers of the polyvinyl alcohol-based fiber having high hydrophilicity.

The separator may comprise fibrillated fibers. The fibrillated fibers are obtained by subjecting fibrils, which are small fibers in fibers, to a process of fluffing the fibrils by using a frictional action, and have a three-dimensional structure in which apparently branched fibers are entangled like a net and which is more complicated than that obtained by simply folding single fibers. Therefore, the sulfate salt is likely to adhere to the three-dimensional structure of the fibrillated fibers. Among them, fibrillated alkali-resistant cellulose fibers are preferable because sulfate salt is likely to uniformly adhere to fine fibers.

Examples of the method for producing a separator containing a sulfate salt include the following three methods: (i) a method in which a solid sulfate salt is attached to the vicinity of the surface of a separator substrate; (ii) a method in which a solution of a sulfate salt is applied to a sheet of a separator substrate or a sheet of a separator substrate is impregnated with a solution of a sulfate salt, and then the sheet is dried to precipitate the sulfate salt; and (iii) a method in which a solution containing a sulfate salt is used when a separator substrate is prepared by a wet papermaking method.

(i) In the method of attaching the solid sulfate salt to the vicinity of the surface of the separator substrate, the sulfate salt can be fixed to the surface of the substrate sheet and the gaps between the fibers by pressure-bonding the powdery sulfate salt onto the separator with a press. In the case where a plurality of layers of the separator substrate are bonded together to form a single separator, a sulfate salt may be disposed between the layers of the separator substrate. The sulfate salt may be made into a slurry by containing a binder, and the slurry sulfate salt may be applied to the surface of the separator substrate or between layers to be bonded. Examples of the binder include polyvinyl alcohol.

(ii) In the case of a method in which a sulfate salt solution is applied to a separator substrate sheet or a separator substrate sheet is impregnated with a sulfate salt solution and then dried to precipitate the sulfate salt, an aqueous solution or a solution of an organic solvent such as alcohol can be used as the sulfate salt solution. A material capable of binding to the sulfate salt, such as polyvinyl alcohol, may be dissolved in the solvent together with the sulfate salt. The conditions for drying are not particularly limited as long as the temperature is equal to or higher than the temperature at which the solvent evaporates.

(iii) In the method in which a solution containing a sulfate salt is used when the separator substrate is prepared by a wet papermaking method, an aqueous solution or a solution of an organic solvent such as alcohol can be used as the solution containing a sulfate salt. A material capable of binding to the sulfate salt, such as polyvinyl alcohol, may be dissolved in the solvent together with the sulfate salt.

The total thickness of the separator may be, for example, 150 μm or more and 450 μm or less, preferably 160 μm or more and 400 μm or less, and more preferably 170 μm or more and 340 μm or less. The total thickness of the separator is an average value of thicknesses at three angularly equivalent points (e.g., three points adjacent to each other at a circumferential angle of 120°) of the cylindrical separator. In addition, the total thickness of the separator means the thickness in a state where the electrolytic solution is absorbed in the battery.

The total thickness T of the separator is determined by obtaining a cross section of the alkaline dry battery after production by CT scanning and measuring the distance between the positive electrode and the negative electrode. The distance from the tip of the positive electrode terminal to the tip of the negative electrode terminal of the battery is defined as the total height. The distance between the positive and negative electrodes in a cross section at a height of ½ of the total height is measured at three angularly equivalent points (e.g., three points adjacent to each other at a circumferential angle of 120°), and the average value at the three points is defined as the total thickness T of the separator.

The total air permeability of the separator may be, for example, 0.1 cc/cm²·s or more and 8.7 cc/cm²·s or less, preferably 0.2 cc/cm²·s or more and 5.0 cc/cm²·s or less, and more preferably 0.3 cc/cm²·s or more and 3.0 cc/cm²·s or less. As the total air permeability of the separator is lower, the internal short circuit due to the precipitation of zinc oxide is more easily suppressed, but the production cost increases. When the total air permeability is within the above range, it is possible to realize an alkaline dry battery in which an internal short circuit is suppressed even when the alkaline dry battery is used in middle load intermittent discharge without increasing the production cost more than necessary. The total air permeability of the portion of the separator sandwiched between the positive electrode and the negative electrode may be within the above range.

The total air permeability A of the separator is measured in accordance with the Frazier type air permeability tester method specified in JIS L 1096:2010, using a separator obtained by disassembling a manufactured alkaline dry battery, taking the separator, washing the separator with a KOH aqueous solution having a concentration of 34% by mass, and allowing the separator to stand and dry for one day under a decreased pressure condition at 20° C.

The separator can be formed so as to have a desired total thickness by stacking a plurality of separators each having a predetermined thickness, or by stacking a separator having a predetermined thickness while winding the separator a plurality of times. In this case, when a plurality of separators of the same type are stacked and used, the total air permeability A can be obtained by dividing the air permeability of one separator measured without stacking by the number of stacked separators. When different types of separators are stacked and used, the air permeability of the stacked separators is measured to determine the total air permeability A.

### (Alkaline Dry Battery)

An alkaline dry battery includes a cylindrical positive electrode disposed in a battery case, a gelled negative electrode containing zinc powder and filled in a hollow portion of the positive electrode, and a separator disposed between the positive electrode and the negative electrode. The separator includes the alkaline dry battery separator described above.

An alkaline dry battery according to the present disclosure includes a positive electrode, a negative electrode, a separator, and an electrolytic solution, and optionally includes other components. The separator includes the alkaline dry battery separator described above.

In one embodiment, an alkaline dry battery includes a cylindrical positive electrode disposed in a battery case, a gelled negative electrode containing zinc powder and filled in a hollow portion of the positive electrode, and a separator disposed between the positive electrode and the negative electrode. As the separator, the above-described alkaline dry battery separator is used.

Hereinafter, examples of components other than the separator of the alkaline dry battery according to the present disclosure will be described.

### (Positive Electrode)

The positive electrode contains manganese dioxide as a positive electrode active material. The positive electrode usually contains a positive electrode active material and a conductive material, and further contains a binder as necessary. The positive electrode may be formed by pressure molding the positive electrode mixture (e.g., positive electrode pellet) into a cylindrical body. The positive electrode mixture contains, for example, a positive electrode active material, a conductive material, and an alkaline electrolytic solution, and further contains a binder as necessary. The cylindrical body may be pressed so as to come into close contact with the inner wall of the case body after being accommodated in the case body.

A preferred example of manganese dioxide as the positive electrode active material is electrolytic manganese dioxide, but natural manganese dioxide or chemical manganese dioxide may also be used. Examples of the crystal structure of manganese dioxide include α type, β type, γ type, δ type, ε type, η type, λ type, and ramsdellite type.

The average particle diameter (D50) of the powder of manganese dioxide may be, for example, within the range of 25 μm to 60 μm from the viewpoint of easily ensuring the filling property of the positive electrode and the diffusiveness of the electrolytic solution in the positive electrode.

From the viewpoint of formability and suppression of expansion of the positive electrode, the BET specific surface area of manganese dioxide may be, for example, within the range of 20 m²/g to 50 m²/g. The BET specific surface area can be measured, for example, by using a specific surface area measuring device based on a nitrogen adsorption method.

The conductive material may be a conductive carbon material. Examples of the conductive carbon material include carbon black (such as acetylene black) and graphite. Examples of the graphite include natural graphite and artificial graphite. The conductive material may be in the form of powder. An average particle diameter (D50) of the conductive material may be within a range of 3 μm to 20 μm. The content of the conductive material in the positive electrode may be within the range of 3 parts by mass to 10 parts by mass (for example, within the range of 5 parts by mass to 9 parts by mass) with respect to 100 parts by mass of manganese dioxide.

In order to absorb hydrogen generated inside the battery, a silver compound may be added to the positive electrode. Examples of the silver compound include silver oxide (e.g., Ag₂O, AgO, and Ag₂O₃) and silver-nickel composite oxide (e.g., AgNiO₂).

### (Negative Electrode)

The negative electrode contains a zinc alloy powder as a negative electrode active material. From the viewpoint of corrosion resistance, the zinc alloy may contain at least one selected from the group consisting of indium, bismuth, and aluminum. The indium content in the zinc alloy may be, for example, within the range of 0.01% by mass to 0.1% by mass. The bismuth content in the zinc alloy may be, for example, within the range of 0.003% by mass to 0.02% by mass. The aluminum content in the zinc alloy may be, for example, within the range of 0.001% by mass to 0.03% by mass. The content of elements other than zinc in the zinc alloy may be within a range of 0.025% by mass to 0.08% by mass from the viewpoint of the corrosion resistance.

The average particle diameter (D50) of the zinc alloy powder may be within the range of 100 μm to 200 μm (for example, within the range of 110 μm to 160 μm) from the viewpoint of the filling property of the negative electrode and the diffusiveness of the electrolytic solution in the negative electrode. In the present specification, the average particle diameter is a median diameter (D50) at which a cumulative volume reaches 50% in a volume-based particle size distribution. The median diameter is determined using, for example, a laser diffraction/scattering particle size distribution analyzer.

The negative electrode includes a zinc alloy powder, a gelling agent, a surfactant, and an electrolytic solution. The negative electrode can be formed by mixing the zinc alloy powder, the gelling agent, the surfactant, and the electrolytic solution. From the viewpoint of more uniformly dispersing the additive (e.g., a gelling agent and a surfactant) in the negative electrode, the additive is preferably added in advance to the electrolytic solution used for producing the negative electrode. As the electrolytic solution, an electrolytic solution (e.g., alkaline electrolytic solution) described later can be used.

In order to improve the corrosion resistance, a compound containing a metal having a high hydrogen overvoltage, such as indium or bismuth, may be appropriately added to the negative electrode.

From the viewpoint of further suppressing an internal short circuit due to precipitation of zinc oxide in a use environment of medium load intermittent discharge, the negative electrode may contain a sulfate salt in addition to the separator. In this case, the content of the sulfate salt contained in the negative electrode may be within the range of 0.01 to 0.5% by mass with respect to the mass of the negative electrode in terms of sulfate ions.

### (Negative Electrode Current Collector)

The alkaline dry battery of the present disclosure may include a negative electrode current collector inserted into the negative electrode. The material of the negative electrode current collector may be a metal (i.e., a single metal or an alloy). The material of the negative electrode current collector preferably contains copper, and may be an alloy containing copper and zinc (for example, brass). The negative electrode current collector may be subjected to a plating treatment such as tin plating, if necessary.

### (Electrolytic Solution)

As the electrolytic solution (e.g., alkaline electrolytic solution), for example, an alkaline aqueous solution containing potassium hydroxide is used. The concentration of potassium hydroxide in the alkaline electrolytic solution is preferably within the range of 30 to 50% by mass (for example, within the range of 30 to 40% by mass). The alkaline electrolytic solution may contain zinc oxide.

The alkaline electrolytic solution may contain a surfactant. By using the surfactant, the dispersibility of the negative electrode active material particles can be enhanced. As the surfactant, those exemplified for the negative electrode can be used. The content of the surfactant in the alkaline electrolytic solution is usually within the range of 0.001 to 0.5% by mass (for example, within the range of 0.002 to 0.2% by mass).

### (Battery Housing)

The battery housing is not particularly limited, and a housing corresponding to the shape of the battery may be used. The shape of the alkaline dry battery according to the exemplary embodiment is not particularly limited, and may be a cylindrical shape or a coin shape (including a button shape). The battery housing usually includes a battery case, a negative electrode terminal plate, and a gasket. As the battery case, for example, a bottomed cylindrical metal case is used. For example, a nickel-plated steel plate is used for the metal case. In order to decrease the contact resistance between the positive electrode and the battery case, the inner surface of the battery case may be coated with a carbon coating. The negative electrode terminal plate can be formed of the same material as that of the metal case, and can be formed of, for example, a nickel-plated steel plate.

Examples of the material of the gasket include polyamide, polyethylene, polypropylene, polyphenyl ether, and polyphenylene ether. From the viewpoint of the corrosion resistance to an alkaline electrolytic solution, the material of the gasket is preferably polyamide-6,6, polyamide-6,10, polyamide-6,12, or polypropylene. The gasket usually has an annular thin portion.

Hereinafter, an example of an embodiment according to the present disclosure will be specifically described with reference to the drawing. The constituent elements described above can be applied to the constituent elements of the exemplary alkaline dry battery described below. In addition, the constituent elements of the exemplary alkaline dry battery described below can be changed based on the above description. Further, the matters described below may be applied to the above-described embodiment.

FIG. 1 is a partially exploded cross-sectional view of an alkaline dry battery 10 having an inside-out structure according to an embodiment of the present disclosure. The cylindrical alkaline dry battery 10 includes a battery case 1, and a positive electrode 2, a negative electrode 3 (e.g., a gelled negative electrode), a separator 4, and an electrolytic solution 15 disposed in battery case 1.

The battery case 1 is a bottomed cylindrical case and functions as a positive electrode terminal. The positive electrode 2 has a hollow cylindrical shape having a hollow portion 2H, and is disposed so as to be in contact with the inner wall of the battery case 1. The negative electrode 3 is disposed in the hollow portion 2H of the positive electrode 2. The separator 4 is disposed between the positive electrode 2 and the negative electrode 3.

The separator 4 includes a cylindrical separator 4a and a bottom paper 4b. The separator 4a is disposed along the inner surface of the hollow portion 2H of the positive electrode 2, and separates the positive electrode 2 and the negative electrode 3 from each other. The bottom paper 4b is disposed at the bottom of the hollow portion 2H of the positive electrode 2, and separates the negative electrode 3 from the battery case 1. Out of the separator 4a and the bottom paper 4b, at least the separator 4a has the above-described features.

The opening of the battery case 1 is sealed by a sealing unit 9. The sealing unit 9 includes a gasket 5, a negative electrode current collector 6, and a negative electrode terminal plate 7 functioning as a negative electrode terminal. The negative electrode current collector 6 has a nail shape having a head portion and a body portion. The negative electrode current collector 6 contains, for example, copper, and may be made of an alloy containing copper and zinc, such as brass. The negative electrode current collector 6 may be subjected to a plating treatment such as tin plating as necessary. The body portion of the negative electrode current collector 6 is inserted into a through hole provided in a central portion of the gasket 5, and is inserted into the negative electrode 3. The head portion of the negative electrode current collector 6 is welded to a central flat portion of the negative electrode terminal plate 7. The gasket 5 has an annular thin portion 5a.

The opening end of the battery case 1 is swaged to the peripheral edge (i.e., the flange) of the negative electrode terminal plate 7 via the peripheral edge of the gasket 5. The outer surface of the battery case 1 is covered with an exterior label 8. The battery case 1, the gasket 5, and the negative electrode terminal plate 7 constitute a battery housing. The positive electrode 2, the negative electrode 3, the separator 4, and the alkaline electrolytic solution 15 are disposed in a battery housing.

A method for assembling the alkaline dry battery 10 is not particularly limited, and a conventional technique can be applied as necessary.

### EXAMPLES

The separator for an alkaline dry battery and the alkaline dry battery of the present disclosure will be described in more detail with reference to examples.

### Inventive Example 1

### (1) Preparation of Electrolytic Solution (Alkaline Electrolytic Solution)

As an alkaline electrolytic solution, an alkaline aqueous solution containing potassium hydroxide (concentration: 33% by mass) and zinc oxide (concentration: 2% by mass) was prepared.

### (2) Preparation of Positive Electrode

Manganese dioxide (i.e., an example of the positive electrode active material) and graphite (i.e., an example of the conductive material) were mixed to obtain a mixture. They were mixed at a mass ratio of manganese dioxide:graphite=100:6. As the manganese dioxide, powder of electrolytic manganese dioxide (average particle diameter (D50): 40 μm) was used. As the graphite, graphite powder (average particle diameter (D50): 8 μm) was used.

The electrolytic solution was added to the mixture, and the mixture was sufficiently stirred and then compression-molded into flakes to obtain a positive electrode mixture. The mass ratio between the mixture and the electrolytic solution was mixture:electrolytic solution=100:2. As the electrolytic solution, the same electrolytic solution as the alkaline electrolytic solution prepared in the above section (1) was used.

Next, the flaky positive electrode mixture was pulverized into granules, and the granules were classified with a 10 to 100 mesh sieve to obtain granules. The obtained granules were press-molded into a hollow cylindrical shape (height: 10.8 mm) to obtain a positive electrode pellet (mass: 2.9 g).

### (3) Preparation of Negative Electrode

The zinc alloy powder, the surfactant, the gelling agent, and the electrolytic solution were mixed to obtain a gelled negative electrode. The materials other than the zinc alloy powder were mixed at a mass ratio of surfactant:gelling agent:electrolytic solution=0.005:2.4:100. As the electrolytic solution, the same electrolytic solution as the alkaline electrolytic solution prepared in the above section (1) was used. The content of the zinc alloy powder was 66% by mass with respect to the entire negative electrode. As the negative electrode active material, a zinc alloy powder containing 0.02% by mass of indium, 0.01% by mass of bismuth, and 0.005% by mass of aluminum was used. As the surfactant, an anionic surfactant was used. As the gelling agent, a mixture of a crosslinked polyacrylic acid and a crosslinked polyacrylic acid partial sodium salt was used.

### (4) Preparation of Separator

As a base material of the separator 4a, a non-woven fabric sheet was prepared by mixing rayon fibers and polyvinyl alcohol fibers as main components. As the alkali-resistant cellulose fibers, rayon fibers (more specifically, polynosic rayon fibers) were beaten and fibrillated. The fibrillated rayon fibers were mixed with polyvinyl alcohol fibers and a polyvinyl alcohol binder at a mass ratio of 50:40:10, and a non-woven fabric sheet having a thickness of 100 μm and a basis weight of 32 g/m² was obtained using a wet paper machine.

Zinc sulfate salt heptahydrate (ZnSO₄·7H₂O) was dissolved in water to prepare a 10% by mass aqueous solution of sulfate salt (ZnSO₄). When a hydrate of a sulfate salt was used, the amount of the hydrate added was adjusted so that the concentration of the sulfate salt in the aqueous solution was 10% by mass. In a state in which the non-woven fabric sheet was placed on a smooth polytetrafluoroethylene plate, the aqueous solution of the sulfate salt was uniformly applied to the non-woven fabric sheet, and then dried at 90° C. to adhere the sulfate salt to the non-woven fabric sheet. The non-woven fabric sheet to which the sulfate salt was attached was wound twice in a cylindrical shape to produce a cylindrical separator 4a.

A non-woven fabric sheet obtained by mixing rayon fibers and polyvinyl alcohol fibers (mass ratio: 1:1) as main components was prepared as the bottom paper 4b. A bottomed cylindrical separator 4 was formed using the cylindrical separator 4a and the bottom paper 4b.

### (5) Assembly of Alkaline Dry Battery

An alkaline dry battery was assembled by the following method using the above components. A procedure for assembling the battery will be described with reference to FIG. 1.

First, a coating agent (product name: Varniphite) manufactured by Nippon Graphite Industries, Ltd. was applied to the inner surface of a bottomed cylindrical case made of a nickel-plated steel sheet to form a carbon coating having a thickness of about 10 μm, thereby obtaining a battery case 1. Next, four positive electrode pellets were vertically inserted into the battery case 1 and then pressurized to form the positive electrode 2 in close contact with the inner wall of the battery case 1. After the bottomed cylindrical separator 4 was disposed inside the positive electrode 2, the alkaline electrolytic solution prepared in the above section (1) was injected and the separator 4 was impregnated with the alkaline electrolytic solution. The battery case 1 was left in this state for a predetermined time to allow the alkaline electrolytic solution to permeate from the separator 4 into the positive electrode 2. Thereafter, 6.3 g of the gelled negative electrode 3 was filled in the separator 4.

The negative electrode current collector 6 was formed by pressing general brass into a nail shape and then plating the surface with tin. The head of the negative electrode current collector 6 was electrically welded to a negative electrode terminal plate 7 made of a nickel-plated steel plate. Thereafter, the body portion of the negative electrode current collector 6 was press-fitted into the through hole at the center of the gasket 5 containing polyamide-6,10 as a main component. In this way, a sealing unit 9 including the gasket 5, the negative electrode current collector 6, and the negative electrode terminal plate 7 was produced.

Next, the sealing unit 9 was disposed at the opening of battery case 1. At this time, the body portion of the negative electrode current collector 6 was inserted into the negative electrode 3. Next, the opening end of the battery case 1 was swaged to the peripheral edge of the negative electrode terminal plate 7 so as to sandwich the gasket 5, thereby sealing the opening of the battery case 1. In this way, the positive electrode 2, the negative electrode 3, the separator 4, and the alkaline electrolytic solution 15 were disposed in the battery housing.

Next, the outer surface of the battery case 1 was covered with the exterior label 8. In this way, an alkaline dry battery A1 according to the inventive example 1 was produced.

The fabricated battery A1 was disassembled, and the separator 4a containing the electrolytic solution was collected. Sulfate ions (SO₄²⁻) contained in the separator 4a were quantified by the above-described method using ion chromatography. As a result, the content of the sulfate salt contained in the separator 4a was determined to be 0.08 mg in terms of sulfate ions per 1 cm² of the facing area between the positive electrode and the negative electrode.

### (6) Evaluation

The battery was connected to a 3.9Ω resistor via a switch, and the switch was turned on at a duty ratio of one hour per day to perform intermittent discharge. Specifically, in an environment of 20±1° C., a cycle of discharging for 1 hour and then pausing for 23 hours was repeated. The above discharge cycle was repeated until the battery voltage reached 0.8 V.

For twenty alkaline dry batteries (N=20), the total discharge time from the start of discharge until the battery voltage reached 0.8 V or less (that is, the total period during which the switch was on) was evaluated as the duration. When the duration was less than 8 hours, it was determined that an internal short circuit occurred during the discharge, and the number n of batteries having the duration of less than 8 hours was obtained.

### Inventive Example 2 to 10 and Comparative Examples 1 to 3

At least one of the content of the sulfate salt added to the separator 4a or the type of the sulfate salt were changed from the inventive example 1. Except for the above change, alkaline dry batteries A2 to A10 and B1 to B3 according to the inventive example 2 to 12 and the comparative examples 1 to 3 were produced and evaluated in the same manner as in the inventive example 1.

In Comparative the inventive example 1, an alkaline dry battery was produced without adding a sulfate salt to the negative electrode to obtain a battery B1.

For each of the batteries A2 to A10, B2, and B3, as in the case of the battery A1, the produced battery was disassembled to collect the separator 4a, sulfate ions (SO₄²⁻) contained in the separator 4a were quantified by the above-described method, and the content of the sulfate salt contained in the separator 4a was determined as a value in terms of sulfate ions per 1 cm² of the facing area between the positive electrode and the negative electrode. The results are shown in Table 1.

### Comparative Example 4

In the inventive example 1, the separator 4a to which potassium silicate (K₂SiO₃) was added instead of sulfate salt was used. An alkaline dry battery B4 was produced and evaluated in the same manner as in the inventive example 1 except for the above.

The produced battery B4 was disassembled to collect the separator 4a, and the silicate ion (SiO₃²⁻) contained in the separator 4a was quantified by the same method as the method for quantifying sulfate ions described above to determine the content of the silicate salt contained in the separator 4a. The content was 0.08 mg in terms of silicate ions per 1 cm² of the facing area between the positive electrode and the negative electrode.

Table 1 shows the evaluation results of the duration. In Table 1, for each of the batteries A1 to A10 and B1 to B4, the ratio n/N of the batteries having the duration of less than 8 hours is shown as the occurrence ratio of the internal short circuit. Table 1 also shows the type and content of the salt compound (i.e., sulfate salt or silicate salt) added to the separator 4a in each of the batteries A1 to A10 and B1 to B4, together with the occurrence ratio n/N of the internal short circuit. The content of the sulfate salt or silicate salt represents the percentage of the mass of sulfate ions or silicate ions in the salt compound per 1 cm² of the facing area between the positive electrode and the negative electrode.

As shown in Table 1, in the batteries A1 to A10 using the separator 4a containing the sulfate salt within a range of 0.08 mg or more and 1.7 mg or less in terms of sulfate ions per 1 cm² of the facing area between the positive electrode and the negative electrode, the internal short circuit is suppressed without causing a decrease in discharge performance.

In the battery B2, since the sulfate salt was added to the separator, the occurrence ratio of the internal short circuit was lower than that of the battery B1 in which the sulfate salt was not added to the separator. However, since the content of the sulfate salt was as small as 0.06 mg in terms of sulfate ions per 1 cm² of the facing area, the internal short circuit could not be sufficiently suppressed.

In the battery B3, the amount of the sulfate salt added is 1.83 mg, which is sufficiently large. Therefore, the internal short circuit can be sufficiently suppressed, however, the pores inside the separator are easily clogged, and the discharge performance may be deteriorated due to a decrease in the ion conductivity and a decrease in the liquid retention property of the electrolytic solution.

In the battery B4 in which the silicate was added to the separator, the occurrence ratio of the internal short circuit was lower than that of the battery B1, but the internal short circuit could not be sufficiently suppressed, and the internal short circuit occurred at a not low rate.

TABLE 1

| | | | Internal |
|---|---|---|---|
| | | | Short Circuit |
| | | Content | Occurrence |
| Battery | Salt Compounds | (mg/cm²) | Ratio |
| B1 | None | 0 | 4/20 |
| B2 | ZnSO₄•7H₂O | 0.06 | 2/20 |
| A1 | ZnSO₄•7H₂O | 0.08 | 0/20 |
| A2 | K₂SO₄ | 0.08 | 0/20 |
| A3 | Na₂SO₄ | 0.08 | 0/20 |
| A4 | Li₂SO₄ | 0.08 | 0/20 |
| A5 | KAl(SO₄)₂•12H₂O | 0.08 | 0/20 |
| A6 | Al₂(SO₄)₃ | 0.08 | 0/20 |
| A7 | CaSO₄ | 0.08 | 0/20 |
| A8 | ZnSO₄•7H₂O | 0.15 | 0/20 |
| A9 | ZnSO₄•7H₂O | 0.95 | 0/20 |
| A10 | ZnSO₄•7H₂O | 1.70 | 0/20 |
| B3 | ZnSO₄•7H₂O | 1.83 | 0/20 |
| B4 | K₂SiO₃ | 0.08 | 2/20 |

### INDUSTRIAL APPLICABILITY

The present disclosure is applicable to an alkaline dry battery.

### REFERENCE SIGNS LIST

1 battery case
2 positive electrode
3 negative electrode
4 separator
4a cylindrical separator
4b bottom paper
5 gasket
5a thin portion
6 negative electrode current collector
7 negative electrode terminal plate
8 exterior label
9 sealing unit
10 alkaline dry battery

1. A separator for an alkaline dry battery, the alkaline dry battery including a positive electrode, a negative electrode containing zinc, and an electrolytic solution, the separator being configured to be provided between the positive electrode and the negative electrode, the separator comprising:
a sulfate salt within a range of 0.08 mg or more and 1.7 mg or less in terms of sulfate ions per 1 cm² of a facing area of the positive electrode and the negative electrode.

2. The separator for the alkaline dry battery according to claim 1, wherein
the sulfate salt includes at least one selected from the group consisting of potassium sulfate salt, sodium sulfate salt, aluminum sulfate salt, aluminum potassium sulfate salt, calcium sulfate salt, zinc sulfate salt, lithium sulfate salt, and hydrates thereof.

3. The separator for the alkaline dry battery according to claim 1, further comprising a polyvinyl alcohol-based fiber.

4. The separator for the alkaline dry battery according to claim 1, further comprising fibrillated fibers.

5. An alkaline dry battery, comprising:
a positive electrode having a cylindrical shape; the positive electrode including a hollow portion, the positive electrode being disposed in a battery case;
a negative electrode which is gelled; the negative electrode containing zinc powder, the negative electrode being filled in the hollow portion of the positive electrode; and
a separator disposed between the positive electrode and the negative electrode,
wherein
the separator includes the separator for the alkaline dry battery according to claim 1.
